(19) United States
(12) Patent Application Publication
(10) Pub. No.: US 2009/0069467 A1
(43) Pub. Date: Mar. 12, 2009

(54) Pigment formulations

(76) Inventors: Gloria Ruiz Gomez, Saint-Louis (FR); Philippe Bugnon, Le Mouret (CH)

Correspondence Address: JoAnn Villamizar;Ciba Corporation/Patent Department, 540 White Plains Road, P.O. Box 2005, Tarrytown, NY, 10591, US

(21) Appl. No.: 11/918,692

(22) PCT Filed: Apr. 12, 2006
(86) PCT No.: PCT/EP2006/061532

§ 371 Date: Oct. 17, 2007

(30) Foreign Application Priority Data
Apr. 21, 2005 (EP) 05103241.5

(51) Int. Cl. C08K 5/3417; C08K 5/3415; C08K 5/3447; C08K 5/3445; C08L 67/00; C08L 69/00

(52) U.S. Cl. 524/88; 524/500; 524/92; 524/93; 524/94; 524/105; 524/502; 524/539; 524/537

(57) ABSTRACT

The present invention relates to a pigment formulation comprising a pigment (A) treated with an oligomeric or polymeric amine or encapsulated in a polymer, to processes for the preparation thereof and also to the use thereof in producing coloured plastics or coloured polymer particles.

The present invention relates to novel pigment formulations, to processes for the preparation thereof and to the use thereof in producing coloured plastics or coloured polymer particles, especially those based on polyamide.

Mass-colouring of polyamide-based plastics is usually carried out using so-called solvent dyes, which are soluble in the polyamide mass at high processing temperatures and which, besides having the requisite high heat resistance, also have adequate chemical stability with respect to the highly reductive medium of the polyamide melt.

The use of pigments is restricted almost exclusively to inorganic pigments, most of which contain heavy metals, and to a very small selection of specific organic pigments, mainly from the phthalocyanine or quinacridone class. Many of those organic pigments have certain disadvantages, however, such as their solubility, interaction with the polymer or a tendency to degrade, and the finished coloured polyamide materials frequently have a tendency to fluoresce.

For example, U.S. Pat. No. 4,031,060 accordingly discloses using TiO₂ for colouring polyamide.

There is therefore a need for new pigments or pigment formulations which in mass-coloured polyamide materials result in strongly coloured, non-fluorescent colourations that are light-fast and have high-temperature light fastness, and which exhibit good allround fastness properties.

It has now been found, surprisingly, that the pigment formulations according to the invention meet the above-mentioned criteria to a large extent.

The present invention accordingly relates to a pigment formulation comprising a pigment (A), wherein the pigment (A) has been treated with an oligomeric or polymeric amine or is encapsulated in a polymer.

Any pigment selected from the class of diketopyrrolopyrroles, azo pigments, quinacridones, quinophthalones, phthalocyanines, indanthrones, flavanthrones, pyranthrones, anthraquinones, perylenes, dioxazines, perinones, thioindigo, isoindolines, pteridines, isoindolinones and metal complexes is suitable as pigment (A) for use in the formulation according to the invention.

Preference is given to the use of phthalocyanine, isoindolinone, azo and diketopyrrolopyrrole pigments.

Of importance are pigments of formulae

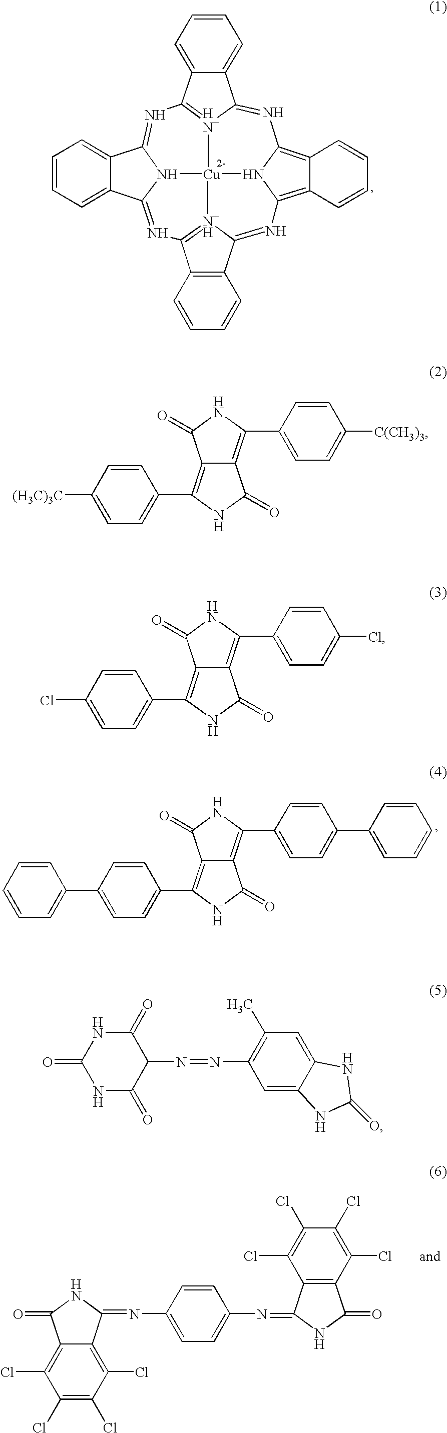

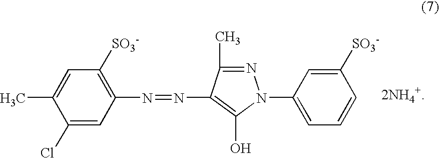

The pigments preferably have a specific surface area of from 10 to 150 m²/g. Special preference is given to opaque pigments having a specific surface area of from 12 to 50 m²/g and to transparent pigments having a specific surface area of from 50 to 100 m²/g.

For preparation of the pigment formulations according to the invention there are used, as oligomeric or polymeric amines, compounds which are made up from a saturated hydrocarbon chain having terminal amine functions, optionally interrupted by a variable number of secondary amino groups.

Examples of such compounds include polyethyleneimines, alkyldiethylenetriamines, alkyltriethylenetetramines, alkyldipropylenetriamines, alkyltripropylenetetramines, alkoxytriamines, alkoxytetramines and vinylamine polymers.

Among the oligomeric or polymeric amines, the following compounds are especially important: N-tallow alkyldipropylenetriamine, N-tallow alkyldipropylenetetramine, N,N,N′N′-tetramethylethylenediamine, coco dipropylenetriamine, oleyidipropylenetriamine, dodecyldipropylenetriamine and oleyltripropylenetetramine.

For preparation of the pigment formulations according to the invention, the pigment particles are sprayed with the oligomeric or polymeric amines as such or with a solution containing those amines and dried, or the pigment particles are immersed in the oligomeric or polymeric amines or in a liquid containing the oligomeric or polymeric amines and the treated pigment particles are filtered off and dried, or are spray-dried.

The amount of the oligomeric or polymeric amines (neutral or quaternary) in relation to the pigments treated can vary within a wide range of from 2 to 500% by weight, preferably from 10 to 100% by weight, of the oligomeric amines and from 10 to 200% by weight of the polymeric amines, based on the weight of the pigment.

For so-called encapsulation of the pigment there may in principle be used natural or, preferably, synthetic polymerisation, polyaddition or polycondensation products of various classes, for example polyesters, polyethers, polyamides, polyimides, polyureas, polyurethanes, polysulfides, polyolefins, poly(meth)acrylates, poly(meth)acrylamides, polyvinyl acetates, polyethyleneimines, polyamines, polyalcohols, polyglycols, polyglycol esters, polycarboxylic acids, polystyrene, and also mixed polymers containing the afore-mentioned polymers, and co- and ter-polymers, advantageously a homo-, co- or ter-polymer based on acrylic acid, methacrylic acid, acrylamide, methacrylamide, styrene or urethane.

For encapsulation preference is given to the use of an ammonium, sodium, calcium, aluminium, zinc or zirconium polyacrylate, an acrylic acid ester or a (meth)acrylic acid/styrene copolymer.

Ammonium is understood to be a radical ⁺NR₁R₂R₃R₄, wherein R₁ to R₄ are each independently of the others hydrogen or C₁-C₁₈alkyl.

The polymers used preferably have an average molecular weight of from 2000 to 50 000 g/mol, especially from 2000 to 12 000 g/mol.

When the pigment formulations according to the invention are prepared by means of encapsulation, the pigment particles are sprayed with the polymers as such or with a solution containing the polymers and dried, or the pigment particles are immersed in the polymers or in a liquid containing the polymers, and the treated pigment particles are optionally precipitated out, for example by means of a change of pH or addition of solvent, filtered off and dried, or are spray-dried.

The pigment particles can also be encapsulated in the polymers in the course of “in situ” emulsion or suspension polymerisation, for example by adding the pigment to the polymerisable monomer or mixture of monomers before the subsequent polymerisation reaction.

The amount of the polymers in relation to the pigments treated can vary within a wide range of from 3 to 500% by weight, preferably from 50 to 300% by weight, based on the weight of the pigment.

The present invention relates also to a method of producing coloured plastics or coloured polymeric particles, wherein a high molecular weight organic material and a tinctorially effective amount of at least one pigment formulation according to the invention are mixed with one another.

Colouring the high molecular weight organic substances with the pigment formulation according to the invention is carried out, for example, by mixing such a pigment formulation into the substrates using roll mills or mixing or grinding apparatuses, as a result of which the pigment formulation is finely distributed in the high molecular weight material. The high molecular weight organic material comprising the admixed pigment formulation is then processed by methods known per se, such as calendering, compression moulding, extrusion, spread-coating, spinning, casting or by injection moulding, whereby the coloured material acquires its final shape. Admixture of the pigment formulation can also be effected immediately prior to the actual processing step, for example by continuously feeding a solid, for example pulverulent, pigment formulation and, at the same time, a granulated or powdered high molecular weight organic material, and optionally also additional ingredients such as, for example, additives, directly into the intake zone of an extruder, where mixing takes place immediately before processing. Generally, however, it is preferable to mix the pigment formulation into the high molecular weight organic material beforehand, since more uniformly coloured products can be achieved.

In order to produce non-rigid mouldings or to reduce their brittleness, it is frequently desirable to incorporate so-called plasticisers into the high molecular weight compounds prior to shaping. There may be used as plasticisers, for example, esters of phosphoric acid, phthalic acid or sebacic acid. In the method according to the invention, the plasticisers may be incorporated into the polymers before or after incorporation of the colorant. It is also possible, in order to achieve different colour shades, to add to the high molecular weight organic materials, in addition to the pigment formulation according to the invention, further pigments or other colorants in any desired amounts, optionally together with further additional ingredients such as, for example, fillers or siccatives (drying agents).

Preferred high molecular weight organic materials suitable for colouring in accordance with the invention are very generally polymers having a dielectric constant ≧2.5, especially polyester (e.g. PET), polycarbonate (PC), polystyrene (PS), polymethyl methacrylate (PMMA), polyamide, polyethylene, polypropylene, styrene/acrylonitrile (SAN) and acrylonitrile/butadiene/styrene (ABS).

Special preference is given to polyester and very special preference is given to polyamide, for example polyamide 6, polyamide 6.6, polyamide 12 and aramid.

The pigment formulations according to the invention provide the afore-mentioned materials, especially polyamide materials, with strongly coloured, level hues having very good in-use fastness properties, especially with good fastness to light and good thermal stability, without any deterioration in the mechanical properties.

The Examples that follow serve to illustrate the invention. Parts are parts by weight and percentages are percentages by weight, unless otherwise specified. Temperatures are given in degrees Celsius. The relation between parts by weight and parts by volume is the same as that between grams and cubic centimetres.

### EXAMPLE 1

9.25 g of a moist 54% press cake of the pigment of formula

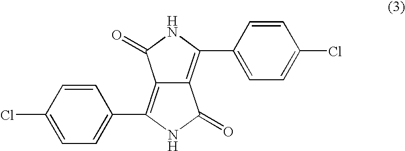

are dispersed in 95 ml of water and then 1.5 ml of Triameen® OV [oleyidipropylenetriamine (AKZO Nobel)] are added. The suspension is stirred for a further 2 hours and is then filtered. The material in the suction filter is washed with water and dried at 60° C. under a vacuum of 100 mbar.

### EXAMPLE 2

9.25 g of a moist 54% press cake of the pigment of formula (3) are dispersed in 95 ml of water and then 1.5 ml of Tetrameen® OV [oleyltripropylenetetramine (AKZO Nobel)] are added. The suspension is stirred for a further 2 hours and is then filtered. The material in the suction filter is washed with water and dried at 60° C. under a vacuum of 100 mbar.

### EXAMPLE 3

20.7 g of a moist 46% press cake of the pigment of formula (3) and 10.7 g of a 50% aqueous solution of polyacrylamide (ALDRICH CAS 9003-05-8) are dispersed in 150 ml of water. The suspension is dried in a BUCHI Mini Spray Dryer (Tᵢ 130-132° C., Tₐ 80-90° C.). (Tᵢ=inlet temperature, Tₐ=outlet temperature).

### EXAMPLE 4

20.7 g of a moist 46% press cake of the pigment of formula (3) and 42.8 g of a 50% aqueous solution of polyacrylamide (ALDRICH CAS 9003-05-8) are dispersed in 150 ml of water. The suspension is dried in a BUCHI Mini Spray Dryer.

### EXAMPLE 5

20.0 g of a moist 46% press cake of the pigment of formula (3) and 23.0 g of a 40% aqueous solution of NH₄-polyacrylate (Dispex® A40, CIBA SC) are dispersed in 200 ml of water. The suspension is then heated at 60° C. for 1 hour and subsequently dried in a BUCHI Mini Spray Dryer.

### EXAMPLE 6

151.2 g of a moist 35% press cake of the pigment of formula (3) and 285.7 g of a 35% aqueous solution of a styrene/polyacrylate copolymer (Narlex® ex. National Starch) are dispersed in 2 litres of water. The suspension is dried in a BUCHI Mini Spray Dryer (Tᵢ 150° C., Tₐ 80-78° C.).

### EXAMPLE 7

11.2 g of a moist 48% press cake of the pigment of formula (3) and 29.1 g of a 35% aqueous solution of a styrene/polyacrylate copolymer (Narlex® ex. National Starch) are dispersed in 400 ml of water. The polymer is precipitated using 10 ml of hydrochloric acid solution. The suspension is filtered and dried.

### EXAMPLE 8

25.5 g of a moist 43% press cake of the pigment of formula (3) and 50.4 g of a 40% solution of modified polyacrylate in butyl acetate/sec-butanol (EFKA® 4400) are dispersed in 400 ml of water. The suspension is dried in a vacuum cabinet at 100° C.

### EXAMPLE 9

0.2 g of the products of Examples 1 to 8 are in each case dispersed with 99.8 g of polyamide 6 (Grillon®F47, EMS Chemie) in an extruder. The paste is formed into a film by means of a chill roll.

All the coloured films remain red without fluorescence, whereas the reference coloured film containing the untreated pigment of formula (3) fluoresces strongly.

### EXAMPLE 10

10.0 g of the pigment of formula (3) are dispersed in 1000 ml of a 1% solution of polystyrene in acetone and added dropwise to 2000 ml of water. The suspension is then filtered and dried.

### EXAMPLE 11

47.0 g of a moist 62% press cake of the pigment of formula (7) and 15.0 g of a 40% aqueous solution of NH₄-polyacrylate copolymer (Dispex® GA40, from CIBA SC) are dispersed in 600 ml of water. The suspension is dried in a BUCHI Mini Spray Dryer.

### EXAMPLE 12

23.7 g of a moist 42% press cake of the pteridine pigment CI PY 215 and 51.0 g of a 40% aqueous solution of sodium polyacrylate (Dispex® GA40, from CIBA SC) are dispersed in 200 ml of water. The polymer is then precipitated by adding 25 ml of a 75% solution of dicoco dimethyl ammonium chloride in isopropanol/water (Arquad® 2C-75 from AKZO NOBEL) and is subsequently filtered off and dried.

### EXAMPLE 13

10.0 g of the pigment of formula (3) and 7.5 g of toluene-2,4-diisocyanate are dispersed in 300 ml of acetone at 55° C. and the diisocyanate is then polymerised with 3.0 g of 1,2-butanediol for 2 hours at 55° C. The suspension is then filtered and dried.

### EXAMPLE 14

44.3 g of a moist 45.1% press cake of the pteridine pigment CI PY 215 and 21.0 g of a 50% aqueous solution of polyacrylate (Dispex® R50, from CIBA SC) are dispersed in 200 ml of water. The suspension is then added dropwise to 1000 ml of a 10% solution of calcium hydroxide in water and subsequently filtered and dried.

What is claimed is:

1. A method for coloring a plastic or polymer particle having a dielectric constant >2.5 with a pigment formulation comprising a pigment (A), which method comprises treating the pigment (A) with from 2 to 500% by weight based on the weight of the pigment of an oligomeric amine or from 10 to 200% by weight based on the weight of the pigment of a polymeric amine or the pigment (A) is encapsulated in from 3 to 500% by weight, based on the weight of the pigment, of a polymer prior to mixing a tinctorially effective amount of the pigment formulation into the polymer having a dielectric constant >2.5.

2. A method according to claim 1, wherein the pigment (A) is a diketopyrrolopyrrole, azo, quinacridone, quinophthalone, phthalocyanine, indanthrone, flavanthrone, pyranthrone, anthraquinone, perylene, dioxazine, perinone, thioindigo, isoindoline, pteridine, isoindolinone or metal complex pigment.

3. A method according to claim 1, wherein the oligomeric or polymeric amine is a compound from the class of polyethyleneimines, alkyldiethylenetriamines, alkyltriethylenetetramines, alkyldipropylenetriamines, alkyltripropylenetetramines, alkoxytriamines, alkoxytetramines or vinylamine polymers.

4. A method according to claim 1, wherein the polymer used for encapsulating is a natural or synthetic polymerisation, polyaddition or polycondensation product such as a polyester, polyether, polyamide, polyimide, polyurea, polyurethane, polysulfide, polyolefin, poly(meth)acrylate, poly(meth)acrylamide, polyvinyl acetate, polyethyleneimine, polyamine, polyalcohol, polyglycol, polyglycol ester, polycarboxylic acid, polystyrene, or a mixed polymer thereof, or a co- or ter-polymer thereof.

5. A method according to claim 4, wherein the polymer used for encapsulating is an ammonium, sodium, calcium, aluminium, zinc or zirconium polyacrylate, an acrylic acid ester or a (meth)acrylic acid/styrene copolymer.

6. A method according to claim 1, wherein particles of pigment (A) are sprayed with the oligomeric or polymeric amine as such or with a solution containing that amine and dried, or the pigment particles are immersed in the oligomeric or polymeric amine or in a liquid containing the oligomeric or polymeric amine and the treated pigment particles are filtered off and dried, or are spray-dried.

7. A method according to claim 1, wherein particles of the pigment (A) are sprayed with an encapsulating polymer as such or a solution containing the encapsulating polymer and dried, or the pigment particles are immersed in the encapsulating polymer or in a liquid containing the encapsulating polymer, the treated pigment particles are optionally precipitated out, filtered off and dried, or are spray-dried.

8. Method according to claim 1 of producing coloured plastics or coloured polymer particles, wherein after mixing a tinctorially effective amount of at least one pigment formulation comprising a pigment (A) into the Polymer having a dielectric constant >2.5, the resulting mixture is then processed to acquire its final shape by calendering, compression moulding, extrusion, spread-coating, spinning, casting or by injection moulding.

9-10. (canceled)

11. A method according to claim 1, wherein the polymer having a dielectric constant ≧2.5 is selected from the group consisting of polyester, polycarbonate, polystyrene, polymethyl methacrylate, polyamide, polyethylene, polypropylene, styrene/acrylonitrile and acrylonitrile/butadiene/styrene.

12. A method according to claim 1, wherein pigment (A) is treated with from 10 to 100% by weight based on the weight of the pigment of an oligomeric amine or from 10 to 200% by weight based on the weight of the pigment of a polymeric amine, or the pigment (A) is encapsulated in from 50 to 300% by weight, based on the weight of the pigment, of a polymer.

13. A method according to claim 7, wherein the treated pigment particles are optionally precipitated out solution changing the pH of the solution or adding a solvent.
